(19) United States
(12) Patent Application Publication
(10) Pub. No.: US 2024/0004125 A1
(43) Pub. Date: Jan. 4, 2024

(54) Windows With Light Guides

(71) Applicant: Apple Inc., Cupertino, CA (US)

(72) Inventors: David E Kingman, San Francisco, CA (US); Clarisse Mazuir, San Jose, CA (US); Lai Wang, Fremont, CA (US); Se Hyun Ahn, Santa Clara, CA (US); Yongxing Hu, Fremont, CA (US); Yuan Chen, Campbell, CA (US)

(21) Appl. No.: 18/469,110

(22) Filed: Sep. 18, 2023

Related U.S. Application Data
(63) Continuation of application No. PCT/US2022/022337, filed on Mar. 29, 2022.
(60) Provisional application No. 63/172,022, filed on Apr. 7, 2021.

(51) Int. Cl. F21V 8/00; B60Q 3/208

(52) U.S. Cl. CPC G02B 6/0095; B60Q 3/208; G02B 6/0041; G02B 6/0091

(57) ABSTRACT

A system may have windows. A window in the system may have first and second window layers such as structural layers of glass. The window may have a light guide layer between the first and second window layers. The light guide layer may have cladding layers and a core layer between the cladding layers. The core and cladding refractive index values may be selected so that the refractive index of the core is greater than the refractive index of the structural layers of glass while the refractive index of the claddings is less than the refractive index of the structural layer of glass. Light-scattering structures may be formed on the light guide to extract some of the light within the light guide and thereby provide illumination for the system.

This application is a continuation of international patent application No. PCT/US2022/022337, filed Mar. 29, 2022, which claims priority to U.S. provisional patent application No. 63/172,022, filed Apr. 7, 2021, which are hereby incorporated by reference herein in their entireties.

### FIELD

This relates generally to structures that pass light, and, more particularly, to windows.

### BACKGROUND

Windows are used in buildings and vehicles. Windows may be formed from glass or other transparent material.

### SUMMARY

A system such as a building or vehicle may have windows. A window may have first and second window layers such as structural layers of glass. The window may have a light guide layer between the first and second window layers. The light guide layer may have cladding layers and a core layer between the cladding layers. The core and cladding refractive index values may be selected so that the refractive index of the core is greater than the refractive index of the structural layers of glass while the refractive index of the claddings is less than the refractive index of the structural layer of glass.

A light source may be used to emit light into an edge of the light guide layer that is guided along the light guide layer by total internal reflection. Light-scattering structures may be formed on the light guide to extract some of the light within the light guide and thereby provide illumination for the system. The illumination may, as an example, serve as interior illumination for a vehicle or building.

### BRIEF DESCRIPTION OF THE DRAWINGS

FIG. 1 is a diagram of an illustrative system with a window in accordance with an embodiment.

FIG. 2 is a cross-sectional side view of an illustrative window in accordance with an embodiment.

FIG. 3 is a cross-sectional side view of illustrative light guide structures for a window in accordance with an embodiment.

FIG. 4 is a graph of an illustrative refractive index profile for the light guide structures of FIG. 3 in accordance with an embodiment.

FIGS. 5 and 6 are graphs of illustrative refractive index profiles for window light guides in accordance with embodiments.

FIG. 7 is a cross-sectional side view of an illustrative window with an embedded light guide and a layer such as an adjustable optical layer in accordance with an embodiment.

FIG. 8 is a cross-sectional side view of an illustrative window with a light guide layer and stray light suppression structures in accordance with an embodiment.

### DETAILED DESCRIPTION

A system may have a transparent structure such as a window that includes an internal light guide. Light may be supplied to the light guide from a light source along one or more edges of the light guide. Guided light within the light guide may be extracted from the light guide by light scattering structures. The extracted light may serve as a source of illumination.

The system in which the window is used may be a building, a vehicle, or other suitable system. Illustrative configurations in which the system is a vehicle may sometimes be described herein as an example. This is merely illustrative. Window structures may be formed in any suitable systems.

Cladding layers and a core layer may be sandwiched together to form a light guide layer for a window. When a light guide layer is provided in a vehicle window, the light guide layer may be used to distribute light laterally across the window. Light-scattering structures such as diffusing films may be located at one or more locations on the light guide layer. Light from a light-emitting diode or other light source may propagate laterally across a window within the light guide in accordance with the principal of total internal reflection. When the guided light reaches a light scattering region of the window, light that is being guided within the light guide is extracted by the scattering structures in the light scattering region. The extracted light may serve as interior illumination for a vehicle.

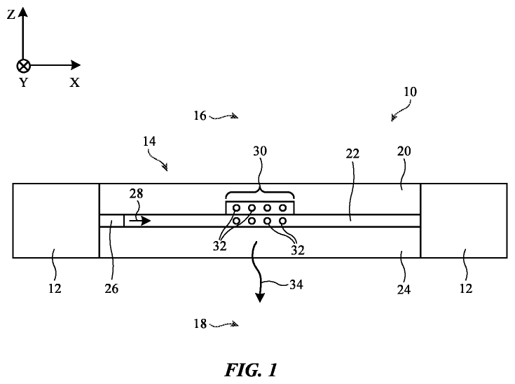

An illustrative system of the type that may include windows is shown in FIG. 1. System 10 may be a vehicle, building, or other type of system. In an illustrative configuration, system 10 is a vehicle. As shown in FIG. 1, system 10 may have support structures such as body 12. Body 12 may be a vehicle body that includes doors, trunk structures, a hood, side body panels, a roof, and/or other body structures. Body 12 may be configured to surround and enclose interior region 18. System 10 may include a chassis to which wheels are mounted, may include propulsion and steering systems, and may include other vehicle systems. Seats may be formed in interior region 18 of body 12. Window 14, which may be a vehicle window, and portions of body 12 may be used to separate interior region 18 of system 10 from the exterior environment (exterior region 16) that is surrounding system 10.

Windows such as window 14 may be coupled to body 12. The windows in system 10 such as window 14 may include a front window on the front of a vehicle, a moon roof (sun roof) window or other window extending over some or all of the top of a vehicle, a rear window at the rear of a vehicle, and/or side windows on the sides of a vehicle. Window 14 may be flat (e.g., window 14 may lie in the X-Y plane of FIG. 1) or window 14 may have one or more curved portions (e.g., window 14 may have a curved cross-sectional profile and may be oriented to lie generally parallel to the X-Y plane so that a convex surface of window 14 faces outwardly in direction Z of FIG. 1). The area of window 14 may be at least 0.1 m², at least 0.5 m², at least 1 m², at least 5 m², at least 10 m², less than 20 m², less than 10 m², less than 5 m², or less than 1.5 m² (as examples).

System 10 may include control circuitry and input-output devices. Control circuitry in system 10 may include one or more processors (e.g., microprocessors, microcontrollers, application-specific integrated circuits, etc.) and storage (e.g., volatile and/or non-volatile memory). Input-output devices in system 10 may include displays, sensors, buttons, light-emitting diodes and other light-emitting devices, haptic devices, speakers, and/or other devices for providing output and/or for gathering environmental measurements and/or user input. The sensors may include ambient light sensors, touch sensors, force sensors, proximity sensors, optical sensors, capacitive sensors, resistive sensors, ultrasonic sensors, microphones, three-dimensional and/or two-dimensional images sensors, radio-frequency sensors, and/or other sensors. Output devices may be used to provide a user with haptic output, audio output, visual output (e.g., displayed content, light, etc.), and/or other suitable output.

During operation, control circuitry in system 10 may gather information from sensors and/or other input-output devices such as ambient light measurements and/or other sensor data, user input such as voice commands provided to a microphone, a touch command supplied to a touch sensor, button input supplied to one or more buttons, etc. Control circuitry in system 10 may use this input in controlling the operation of one or more electrically adjustable components in window 14. For example, window 14 may include an adjustable optical layer and control circuitry in system 10 may adjust this layer to adjust the amount of opacity (and therefore the amount of light transmission) through window 14 (e.g., for light passing from interior 18 to exterior 16 and for light passing from exterior 16 to interior 18) and/or to make other adjustments to window 14 based on user input, ambient light measurements, other sensor data, and/or other information gathered using input-output devices in system 10.

Window 14 may be formed from one or more layers of transparent glass, clear polymer (e.g., polycarbonate, acrylic, etc.), polymer adhesive, and/or other layers. As shown in FIG. 1, a light guide (optical waveguide) such as light guide layer 22 may be sandwiched between outer window layer 20 and inner window layer 24. Outer window layer 20 may include multiple sublayers such as one or more layers of glass, optically clear adhesive, and/or polymer films. Inner window layer 24 may similarly include multiple sublayers such as one or more layers of glass, optically clear adhesive, and/or polymer films. The outer and inner window layers may, as an example, include, respectively, an outer structural window layer such as a structural glass layer that is attached to an outer surface of light guide layer 22 and an inner structural window layer such as a structural glass layer that is attached to an opposing inner surface of light guide layer 22. In some configurations, optical component layers such as optical modulator layers and/or other optical layers may be incorporated into window 14.

In the example of FIG. 1, window 14 includes a light guide layer such as light guide layer 22 between outer window layer 20 and inner window layer 24. During operation, light source 26 may emit light 28 into light guide layer 22. Light 28 may be guided across window 14 within layer 22 (e.g., in the X direction of FIG. 1) in accordance with the principal of total internal reflection. In some configurations, light 28 may spread in the Y dimension while traveling across the window in the X dimension.

Source 26 may include light-emitting device(s) such as one or more light-emitting diodes and/or lasers. These light-emitting devices may be distributed along the edge of light guide layer 22 (e.g., along the Y dimension in the example of FIG. 1). If desired, sources such as source 26 may be placed along multiple edges of light guide layer 22 (e.g., both the right and left edges of layer 22 in FIG. 1, along all four edges of a light guide layer that has a rectangular footprint, etc.). The configuration of FIG. 1 in which layer 22 is provided with light 28 from light source 26 along the left-hand edge of layer 22 is illustrative. Layers of adhesive (e.g., optically clear adhesive) may be used to attach light guide layer 22 to adjacent layers such as layer 20 and layer 24 and may be used to attach sublayers within layer 22 to each other. Such adhesive layers may have thicknesses of less than 1 mm, less than 0.8 mm, less than 0.5 mm, less than 0.2 mm, less than 0.1 mm, less than 0.05 mm, less than 0.025 mm, at least 0.05 mm, at least mm, or at least 0.4 mm (as examples).

One or more regions of light guide layer 22 in window 14 such as illustrative light-scattering region 30 of FIG. 1 may be provided with light-scattering structures 32. When light 28 that is being guided in light guide layer 22 reaches light-scattering region 30, this guided light can be scattered out of light-guide layer 22 as scattered light 34. Scattered light 34 may serve as illumination for system 10 and may illuminate objects in interior region 18. For example, in a vehicle window, light 34 may serve as interior vehicle illumination.

Light-scattering structures 32 may be formed from inorganic particles (e.g., metal oxide particles or other inorganic dielectric particles having a refractive index that differs from the refractive index of surrounding polymer material in which the particles are embedded) and/or may be formed from protrusions and/or recesses (e.g., surface texture) on light guide 22 or an adjacent layer. Structures 32 may be formed in light guide layer 22 and/or an adjacent layer (e.g., an adjacent layer of polymer or glass). As an example, light guide layer 22 may have a transparent core surrounded by cladding layers and structures 32 may include light-scattering particles that are embedded within the core and/or the cladding layers. Light-scattering particles may also be embedded in a polymer film that is attached to light guide layer 22 (e.g., a polymer film that is attached to the surface of light guide layer 22 above or below light guide layer 22). Light-scattering particles in region 30 may be formed from glass beads, particles of metal oxide such as titanium oxide particles or zirconium oxide particles, particles of silicon oxide, or other inorganic dielectric particles. If desired, gas bubbles or other voids in layer 22 (or an adjacent film) may be used to create light-scattering structures.

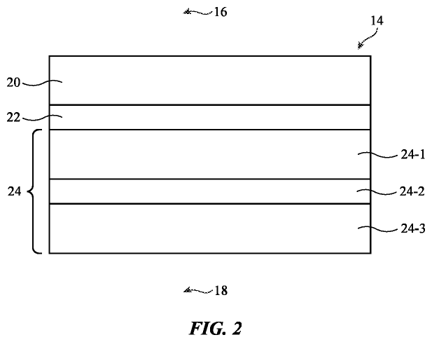

If desired, layer 20 may contain one or more sublayers and/or layer 24 may contain one or more sublayers. Consider, as an example, window 14 of FIG. 2. In the example of FIG. 2, layer 24 includes layers 24-1 and 24-3. Layer 24-2 may be sandwiched between layers 24-1 and 24-2. In an illustrative arrangement, layers 20, 24-1, and 24-3 are glass layers. One, two, or all three of these glass layers may be sufficiently thick to help support window 14 and provide window 14 with structural strength (e.g., one, two, or all three of layers 20, 24-1, and 24-3 may serve as glass structural window layers). If desired, some or all of the layers of window 14 such as layer 20, 24-1, and/or 24-3 may be polymer layers. Structural glass layers may have thicknesses of 0.3-2 mm, at least 0.4 mm, at least 0.5 mm, less than 10 mm, or other suitable thicknesses. Light guide layers (e.g., core and/or cladding layers formed from glass or polymer) in light guide layer 22 and/or other sublayers in window 14 may have thicknesses of at least 0.05 mm, at least 0.1 mm, at least 0.2 mm, less than 2 mm, less than 1 mm, less than 0.6 mm, or other suitable thickness.

Layer 24-1 may include optional adhesive layers and one or more optical component layers. As an example, layer 24-1 may include an electrochromic layer, a guest-host liquid crystal layer, and/or other electrically adjustable optical layers that may serve as light modulators. Arrangements in which window 14 includes one or more layers with adjustable color cast, light transmission, reflectivity, polarization, haze, and/or other adjustable optical attributes may also be used. Layers such as layer 24-2 may also be formed from and/or may include polymer adhesive such as a layer of polyvinyl butyral (e.g., to laminate layers 24-1 and 24-3 together to form laminated safety glass). One or more layers in window 14 (e.g., structural glass layers in layer 20 and/or layer 24) may be chemically strengthened (e.g., using an ion-exchange process or other process that places the outer surface of the glass layers into compressive stress that helps resist cracking).

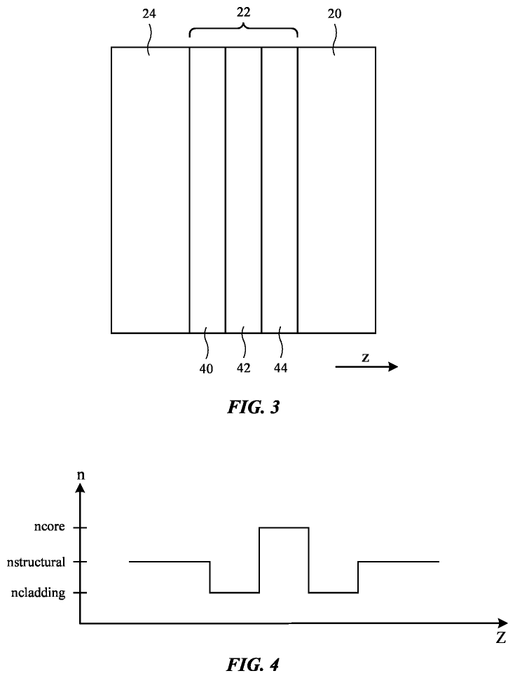

As shown in FIG. 3, light guide layer 22 may have a light guide core such as core layer 42 (e.g., a sheet of polymer, glass, or other transparent material with a core refractive index). To ensure that light guide layer 22 guides light, core layer 42 is surrounded by cladding layers 40 and 44 that have a lower refractive index than core layer 42. The core refractive index may be ncore and the cladding refractive index may be ncladding. The difference in refractive index between the core and cladding (i.e., the value of ncore-ncladding may be at least 0.1, at least 0.15, at least 0.2, at least 0.35, less than 0.3, less than 0.25, less than 0.2, less than 0.15, or other suitable refractive index difference). A refractive index difference value of 0.15-0.25 or more between the core layer and cladding layers that surround the core layer may be helpful in ensuring that light is satisfactorily confined within light guide layer 22 by total internal reflection. Other core-cladding refractive index value differences may be used, if desired.

In an illustrative arrangement, layers 24 and 20 (and/or sublayers in layers 24 and/or 20 that are adjacent to light guide layer 22 such as structural window layers) are formed from glass or other material that has a refractive index value nstructural of 1.5, at least 1.4, at least 1.45, less than 1.6, less than 1.55, 1.45-1.55, 1.4-1.6, etc. In an illustrative embodiment, the use of glass for window 14 may help ensure that window 14 is sufficiently robust for use in system 10.

To ensure a desired refractive index difference between core 42 and surrounding window material, claddings 40 and 44 may have a refractive index that is about 0.2 lower than the refractive index of core 42. To avoid challenges in producing cladding material with very low refractive index values (e.g., lower than 1.3, as an example), core 42 may be formed from glass or polymer having a refractive index value above that of layers 24 and 20 (e.g., the refractive index of core 42 may be greater than the refractive index of layers 20 and 24 by at least 0.05 or at least 0.1, by a value from 0.1-0.2, by a value from 0.05-0.15, etc.).

To allow window 14 to be fabricated from strong available materials with satisfactory window properties, layers 20 and 24 (and/or the structural sublayers in such layers) may therefore be formed from glass, polymer, or other material with a refractive index of about 1.5 (e.g., 1.45-1.55 or other suitable value). The refractive index of cladding layers 40 and 44 may be about 0.2 lower (e.g., 0.015-0.25 lower, at least 0.015 lower, etc.) than the refractive index of core 42 to ensure satisfactory light guiding in core 42. To avoid the need to use materials with very high refractive index values that are potentially challenging to obtain and use in high volume manufacturing, core 42 may be formed from glass or from a polymer such as polycarbonate with a refractive index of about 1.6 (e.g., a polymer or glass layer with a refractive index of 1.55-1.65, less than 1.7, less than 1.68, less than 1.65, less than 1.6, etc.). To help ensure that a desired refractive index value for core 42 is obtained, core 42 may be formed from a polymer that is loaded with nanoparticles. For example, metal oxide nanoparticles or other inorganic dielectric particles that have a relatively high refractive index may be embedded in a polycarbonate layer or other polymer matrix. The size of these nanoparticles may be relatively small to help minimize light scattering and haze (e.g., particle diameters may be may be less than 200 nm, less than 150 nm, less than 100 nm, less than 50 nm, or less than 25 nm (as examples).

Cladding layers 40 and 44 in this type of arrangement may therefore have a refractive index value of about 1.4 (e.g., about 1.35-1.45). Cladding layers 40 and 44 may, as an example, be formed from a polymer such as acrylic with microscopic gas-filled bubbles such as air bubbles (or other voids) to help lower the refractive index. The size of the air bubbles or other voids in the cladding polymer may be selected to help minimize light scattering and associated haze. As an example, the size of the voids may be less than 200 nm, less than 150 nm, less than 100 nm, less than 50 nm, or less than 25 nm (as examples).

FIG. 4 shows how with arrangements such as these, ncore may be greater than ncladding by an amount (e.g., 0.2) selected to satisfactorily sustain total internal reflection for guided light, while ncore may have a moderate value (e.g., less than 1.65). The value of nstructrual, which is associated with the use of glass window layers in this illustrative configuration may be greater than ncladding (e.g., by an index difference of at least 0.05, at least 0.1, 0.05-0.15, etc.) and may be less than ncore (e.g., by an index difference of at least 0.05, at least 0.1, at least 0.15, 0.05-0.15, etc.). The refractive index difference between ncladding and nstructural may be less than 0.15 or less than 0.1 (as examples), so the interfaces between the cladding layers and the inner and outer window layers may be characterized by low amounts of reflection (e.g., less than 0.12%) as light passes through window 14.

To ensure that window 14 exhibits satisfactory clarity (e.g., for viewers in interior 18 viewing objects in exterior region 16), the haze of the layers of window 14 such as core 42, cladding layers 40 and 44, layers 20 and 24, and the overall haze of window 14 may be less than 1% or less than 0.5% (as examples).

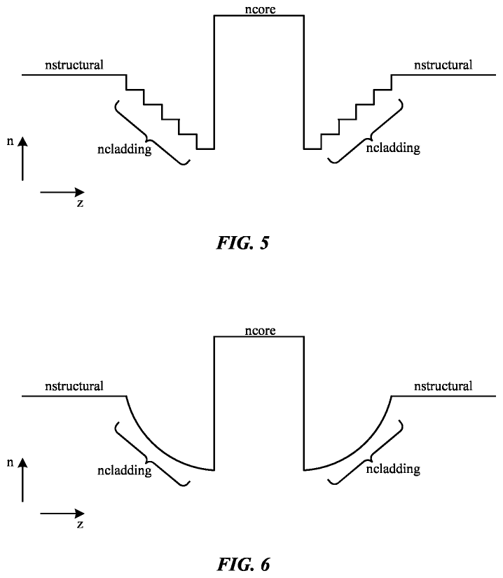

If desired, the refractive index of one or more of the layers in window 14 may be graded (varying as a function of distance along the Z axis). Consider, as an example, the illustrative refractive index profiles of FIGS. 5 and 6. As shown in FIG. 5, the refractive index of the cladding layers may be graded in a stepwise fashion. Cladding layers 40 and 44 may, as an example, each be formed from multiple stacked sublayers that have different respective refractive index values (stepped values). Adjacent to core layer 42, desired amounts of refractive index difference between the core layer and the cladding may be maintained. Adjacent to the outer window layers, the refractive index difference may be reduced due to the graded index profile. By reducing the refractive index difference at the interface between cladding layers 40 and 44 and adjacent window layers 24 and 20, respectively, undesired window reflections can be reduced. In the example of FIG. 6, the refractive index of the cladding layers 40 and 44 has been continuously varied (e.g., by using a non-stepwise arrangement to form cladding layers with smoothly varying densities of embedded index-loading particles, etc.). Arrangements in which cladding layers 40 and/or 44 and/or other layer(s) in window 14 such as core 42 and/or layers 24 and 20 are provided with graded refractive index profiles using a combination of continuously varying (e.g., smoothly and monotonically varying without steps) and step-wise varying graded index structures may also be used, if desired.

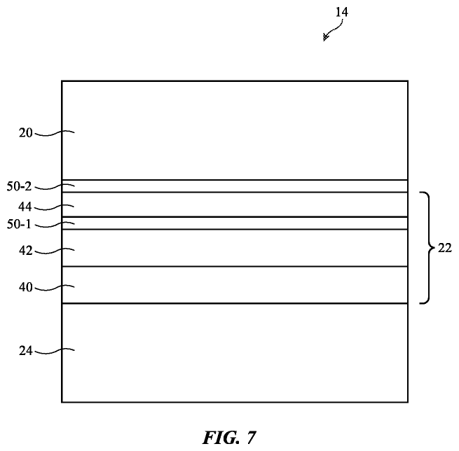

FIG. 7 is a cross-sectional side view of window 14 in an illustrative configuration in window 14 contains one or more optional additional layers such as layer 50-1 and/or layer 50-2. Layers such as layer 50-1 and/or layer 50-2 may be fixed optical films or electrically adjustable optical layers. As an example, layer 50-1 and/or layer 50-2 may be a light modulator layer. The light modulator layer may be a guest-host liquid crystal light modulator layer that includes a layer of guest-host liquid crystal material sandwiched between a pair of transparent electrodes and optional polymer films or other substrates or may be an electrochromic light modulator or cholesteric liquid crystal light modulator layer. Layer 50-1 and/or layer 50-2 may also be a suspended particle device, a polymer dispersed liquid crystal device, a photochromic device, a polarizer, a film that provides window 14 with a fixed color cast or opacity, a film that provides window 14 with a fixed haze, and/or other fixed and/or adjustable layers for controlling color cast, transparency, polarization, reflectivity, haze, and/or other optical characteristics for window 14. In arrangements of the type shown in FIG. 7 in which layer 50-1 and/or layer 50-2 are sandwiched between other layers in window 14, it may be desirable to provide layer 50-1 and/or layer 50-2 with a refractive index value that differs from that of one or both of the layers immediately adjacent to that layer by less than 0.15, less than 0.1, or less than 0.05 (as examples), thereby helping to reduce unwanted light reflections at the interfaces between layers 50-1 and 50-2 and the surrounding layers in window 14. For example, layer 50-2 may have a refractive index that varies from the refractive index of a structural glass layer or other layer in layer 20 by less than 0.15, less than 0.1, or less than 0.05 (as examples).

At the edge(s) of window 14 where light source 26 emits light 28 into light guide layer 22, there is a potential for steeply angled light rays to escape light guide 22. Such stray light may produce undesired visual effects. As an example, such stray light may become trapped by the air-glass interfaces at the outer surfaces of window 14 and may thus be guided within the total thickness of window 14 rather than within the intended light guide at the center of window 14. To suppress undesired stray light guiding, window 14 may be provided with stray light suppression structures such as one or more layers of opaque light-absorbing material above and/or below light guide layer 22. This material may be formed from black ink or paint (e.g., polymer containing black dye or black pigment), black glass, and/or other light-absorbing materials.

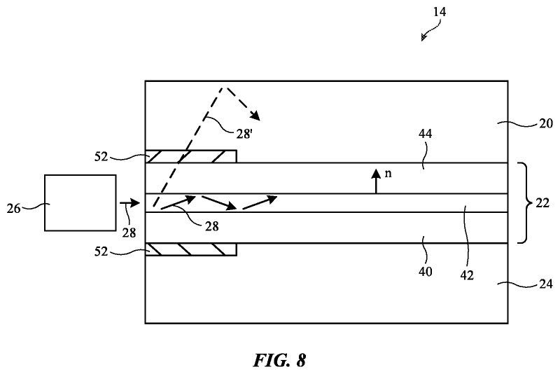

Illustrative stray light suppression structures for window 14 are shown in FIG. 8. In the illustrative configuration of FIG. 8, opaque layers 52 have been placed above and below light guide layer 22, immediately adjacent to cladding layers 40 and 44, near the edge of light guide 22 where light source 26 is emitting light 28 into light guide layer 22. The refractive index of layer(s) 52 may, as an example, be matched to that of cladding layer 44 and/or cladding layer 40 (e.g., within 0.1, within 0.05, within 0.01, etc.) to reduce reflections at the interface between the cladding and opaque material.

As shown in the example of FIG. 8 light 28 in core layer 42 that has a sufficiently large angle with respect to surface normal n of core layer 42 (greater than the critical angle) will be guided within core layer 42. Light 28 that is below the critical angle (rays that are closer to perpendicular to the surface of core layer 42) will tend to escape into layer 52 and be absorbed. This reduces or eliminates stray light rays such as light ray 28′ of FIG. 8 and thereby prevents such stray light rays from reflecting from the air-glass interface at the exposed surface of layer 20. Using stray-light absorbing structures such as these or other suitable stray light absorbing structures, the light emitted from light source 26 into light guide 22 can be confined mostly or exclusively to light guide 22, until extracted where desired (see, e.g., light-scattering region 30 of FIG. 1).

In accordance with an embodiment, a system is provided that includes a body; and a window in the body that separates an exterior region surrounding the body from an interior region within the body, the window includes first and second window layers having a first refractive index; and a light guide layer between the first and second window layers, the light guide layer has a core layer with a second refractive index that is greater than the first refractive index and has cladding layers with a third refractive index that is less than the second refractive index.

In accordance with another embodiment, the body includes a vehicle body, the system includes a light source configured to emit light into the core layer that is guided within the core layer by total internal reflection; and light-scattering structures overlapping a portion of the light guide, the light-scattering structures are configured to extract some of the light guided within the core layer to serve as illumination for the interior region, the first window layer includes a first layer of glass, and the second window includes a second layer of glass.

In accordance with another embodiment, the second refractive index is at least 0.15 greater than the third refractive index.

In accordance with another embodiment, the second refractive index is less than 1.65.

In accordance with another embodiment, the second refractive index is 1.55-1.65.

In accordance with another embodiment, the first window layer includes a first layer of glass and the second window includes a second layer of glass.

In accordance with another embodiment, the light guide layer is between the first and second layers of glass, the first and second layers of glass have the first refractive index, and the first refractive index is 1.45-1.55.

In accordance with another embodiment, the third refractive index is at least 0.05 less than the first index.

In accordance with another embodiment, the first and second window layers are first and second glass layers.

In accordance with another embodiment, the body includes a vehicle body, the system further includes a light source configured to emit light into the core layer that is guided within the core layer by total internal reflection.

In accordance with another embodiment, the system includes light-scattering structures overlapping a portion of the light guide, the light-scattering structures are configured to extract some of the light guided within the core layer to serve as illumination for the interior region.

In accordance with another embodiment, the system includes an opaque layer configured to absorb stray light that escapes from the core layer adjacent to the light source.

In accordance with another embodiment, the cladding layers include polymer with embedded air bubbles and the core layer include polycarbonate.

In accordance with another embodiment, at least part of the cladding layer has a graded refractive index.

In accordance with an embodiment, a vehicle is provided that includes a vehicle body; a vehicle window in the vehicle body that has first and second structural window layers, the vehicle window is between an exterior region surrounding the vehicle body and an interior region within the vehicle body; and a light guide layer between the first and second structural window layers, the first and second structural window layers have a first refractive index, the light guide layer has a core layer with a second refractive index that is greater than the first refractive index, the light guide layer has first and second cladding layers on opposing sides of the core layer, the first and second cladding layers have a third refractive index, and the first refractive index is at least 0.05 less than the second refractive index and is at least 0.05 greater than the third refractive index.

In accordance with another embodiment, the vehicle includes a light source configured to emit light into the light guide layer that is guided within the light guide layer by total internal reflection; and a light-scattering structure on the light guide that is configured to extract guided light from within the light guide layer to illuminate the interior region.

In accordance with another embodiment, the first and second structural window layers include glass layers.

In accordance with another embodiment, the core layer has a refractive index of 1.55-1.65.

In accordance with another embodiment, the vehicle window includes an electrically adjustable optical layer.

In accordance with another embodiment, the electrically adjustable optical layer includes a light modulator layer between the first structural window layer and the light guide.

In accordance with another embodiment, the light modulator layer has a refractive index that differs from the first refractive index by less than 0.05.

In accordance with an embodiment, a vehicle window is provided that includes inner and outer glass layers having a refractive index that is between 1.45 and 1.55; and a light guide layer between the outer glass layer and the inner glass layer, the light guide layer has first and second cladding layers with a refractive index of at least 0.05 less than the refractive index of the inner and outer glass layers and has a core layer between the first and second cladding layers with a refractive index that is greater than the refractive index of the inner and outer glass layers.

In accordance with another embodiment, the refractive index of the core layer is between 1.55 and 1.65.

The foregoing is merely illustrative and various modifications can be made to the described embodiments. The foregoing embodiments may be implemented individually or in any combination.

What is claimed is:

1. A system, comprising:
a body; and
a window in the body that separates an exterior region surrounding the body from an interior region within the body, wherein the window comprises:
first and second window layers having a first refractive index; and
a light guide layer between the first and second window layers, wherein the light guide layer has a core layer with a second refractive index that is greater than the first refractive index and has cladding layers with a third refractive index that is less than the second refractive index.

2. The system defined in claim 1 wherein the body comprises a vehicle body, the system further comprising:
a light source configured to emit light into the core layer that is guided within the core layer by total internal reflection; and
light-scattering structures overlapping a portion of the light guide, wherein the light-scattering structures are configured to extract some of the light guided within the core layer to serve as illumination for the interior region, wherein the first window layer comprises a first layer of glass, and wherein the second window comprises a second layer of glass.

3. The system defined in claim 1 wherein the second refractive index is at least 0.15 greater than the third refractive index.

4. The system defined in claim 3 wherein the second refractive index is less than 1.65.

5. The system defined in claim 3 wherein the second refractive index is 1.55-1.65.

6. The system defined in claim 3 wherein the first window layer comprises a first layer of glass and wherein the second window comprises a second layer of glass.

7. The system defined in claim 6 wherein the light guide layer is between the first and second layers of glass, wherein the first and second layers of glass have the first refractive index, and wherein the first refractive index is 1.45-1.55.

8. The system defined in claim 3 wherein the third refractive index is at least less than the first index.

9. The system defined in claim 8 wherein the first and second window layers are first and second glass layers.

10. The system defined in claim 1 wherein the body comprises a vehicle body, the system further comprising a light source configured to emit light into the core layer that is guided within the core layer by total internal reflection.

11. The system defined in claim 10 further comprising light-scattering structures overlapping a portion of the light guide, wherein the light-scattering structures are configured to extract some of the light guided within the core layer to serve as illumination for the interior region.

12. The system defined in claim 11 further comprising an opaque layer configured to absorb stray light that escapes from the core layer adjacent to the light source.

13. The system defined in claim 12 wherein the cladding layers comprise polymer with embedded air bubbles and wherein the core layer comprises polycarbonate.

14. The system defined in claim 1 wherein at least part of the cladding layer has a graded refractive index.

15. A vehicle, comprising:
a vehicle body;
a vehicle window in the vehicle body that has first and second structural window layers, wherein the vehicle window is between an exterior region surrounding the vehicle body and an interior region within the vehicle body; and
a light guide layer between the first and second structural window layers, wherein the first and second structural window layers have a first refractive index, wherein the light guide layer has a core layer with a second refractive index that is greater than the first refractive index, wherein the light guide layer has first and second cladding layers on opposing sides of the core layer, wherein the first and second cladding layers have a third refractive index, and wherein the first refractive index is at least 0.05 less than the second refractive index and is at least 0.05 greater than the third refractive index.

16. The vehicle defined in claim 15 further comprising:
a light source configured to emit light into the light guide layer that is guided within the light guide layer by total internal reflection; and
a light-scattering structure on the light guide that is configured to extract guided light from within the light guide layer to illuminate the interior region.

17. The vehicle defined in claim 16 wherein the first and second structural window layers comprise glass layers.

18. The vehicle defined in claim 17 wherein the core layer has a refractive index of 1.55-1.65.

19. The vehicle defined in claim 17 wherein the vehicle window further comprises an electrically adjustable optical layer.

20. The vehicle defined in claim 19 wherein the electrically adjustable optical layer comprises a light modulator layer between the first structural window layer and the light guide.

21. The vehicle defined in claim 20 wherein the light modulator layer has a refractive index that differs from the first refractive index by less than 0.05.

22. A vehicle window, comprising:
inner and outer glass layers having a refractive index that is between 1.45 and 1.55; and
a light guide layer between the outer glass layer and the inner glass layer, wherein the light guide layer has first and second cladding layers with a refractive index of at least 0.05 less than the refractive index of the inner and outer glass layers and has a core layer between the first and second cladding layers with a refractive index that is greater than the refractive index of the inner and outer glass layers.

23. The vehicle window defined in claim 22 wherein the refractive index of the core layer is between 1.55 and 1.65.
